(19) United States
(12) Patent Application Publication
(10) Pub. No.: US 2012/0166224 A1
(43) Pub. Date: Jun. 28, 2012

(54) METHODS AND APPARATUS TO EXCHANGE LINKAGE INFORMATION ASSOCIATED WITH CLINICAL ITEMS

(75) Inventor: Vighnesh Kumar Patil, Bangalore (IN)

(73) Assignee: GENERAL ELECTRIC COMPANY, Schenectady, NY (US)

(21) Appl. No.: 13/041,658

(22) Filed: Mar. 7, 2011

(30) Foreign Application Priority Data
Dec. 28, 2010 (IN) 3993/CHE/2010

(51) Int. Cl. G06Q 50/00; G06Q 10/00

(52) U.S. Cl. 705/3

(57) ABSTRACT

Methods and apparatus to exchange linkage information associated with clinical items are disclosed. An example method for use with a healthcare information system includes detecting a patient transfer associated with a patient from a first healthcare entity to a second healthcare entity; obtaining linkage information indicative of a relationship between a clinical item of treatment associated with the patient and a medical issue of the patient; transferring the linkage information to the second healthcare entity in response to the detected patient transfer; enabling a healthcare practitioner associated with the second healthcare entity to view the linkage information such that the relationship is visually conveyed to the healthcare practitioner; and enabling the healthcare practitioner to accept the medical issue of the patient to initiate an automatic reconciliation process.

### RELATED APPLICATION

This patent claims the benefit of Indian Patent Application No. 3993/CHE/2010, filed on Dec. 28, 2010, which is hereby incorporated herein in its entirety.

### FIELD OF THE DISCLOSURE

The present disclosure relates generally to healthcare information systems and, more particularly, to methods and apparatus to exchange linkage information associated with clinical items.

### BACKGROUND

Healthcare environments, such as hospitals and clinics, typically include information systems (e.g., electronic medical record (EMR) systems, lab information systems, outpatient and inpatient systems, hospital information systems (HIS), radiology information systems (RIS), storage systems, picture archiving and communication systems (PACS), etc.) to manage clinical information such as, for example, patient medical histories, imaging data, test results, diagnosis information, management information, financial information, and/or scheduling information. The information may be centrally stored or divided at a plurality of locations. Healthcare practitioners may desire to access patient information or other information at various points in a healthcare workflow. For example, during surgery, medical personnel may access patient information, such as images of a patient's anatomy, which are stored in a medical information system. Further, medical personnel may enter new information, such as medical history, diagnostic, financial, or treatment information into a medical information system before and/or after a completed medical procedure, analysis, and/or appointment.

### SUMMARY

An example method for use with a healthcare information system includes detecting a patient transfer associated with a patient from a first healthcare entity to a second healthcare entity; obtaining linkage information indicative of a relationship between a clinical item of treatment associated with the patient and a medical issue of the patient; transferring the linkage information to the second healthcare entity in response to the detected patient transfer; enabling a healthcare practitioner associated with the second healthcare entity to view the linkage information such that the relationship is visually conveyed to the healthcare practitioner; and enabling the healthcare practitioner to accept the medical issue of the patient to initiate an automatic reconciliation process.

An example tangible machine readable medium has instructions stored thereon that, when executed, cause a machine to at least detect a patient transfer associated with a patient from a first healthcare entity to a second healthcare entity; obtain linkage information indicative of a relationship between a clinical item of treatment associated with the patient and a medical issue of the patient; transfer the linkage information to the second healthcare entity in response to the detected patient transfer; enable a healthcare practitioner associated with the second healthcare entity to view the linkage information such that the relationship is visually conveyed to the healthcare practitioner; and enable the healthcare practitioner to accept the medical issue of the patient to initiate an automatic reconciliation process.

An apparatus for use in a healthcare information system includes a retriever to obtain linkage information indicative of a relationship between a clinical item of treatment associated with a patient and a medical issue of the patient in response to an indication of a patient transfer from a first healthcare entity to a second healthcare entity; a transmitter to transfer the linkage information to the second healthcare entity in response to the detected patient transfer; a generator to enable a healthcare practitioner associated with the second healthcare entity to view the linkage information such that the relationship is visually conveyed to the healthcare practitioner; and a selector to enable the healthcare practitioner to accept the medical issue of the patient to initiate an automatic reconciliation process.

### BRIEF DESCRIPTION OF THE DRAWINGS

FIG. 1 is a block diagram of an example healthcare information system.

FIG. 2 is a block diagram of an example apparatus that may be used to implement the example exchanger of FIG. 1.

FIG. 3 is an example implementation of a user interface associated with the example exchanger of FIG. 1.

FIG. 4 is a flow diagram representative of example machine readable instructions that may be executed to implement the example exchanger of FIGS. 1 and/or 2.

FIG. 5 is a flow diagram representative of example machine readable instructions that may be executed to implement the example exchanger of FIGS. 1 and/or 2.

FIG. 6 is a block diagram of an example processor system that may be used to execute the machine readable instructions of FIGS. 3 and/or 4 to implement the example exchanger of FIGS. 1 and/or 2.

The foregoing summary, as well as the following detailed description of certain implementations of the methods, apparatus, systems, and/or articles of manufacture described herein, will be better understood when read in conjunction with the appended drawings. It should be understood, however, that the methods, apparatus, systems, and/or articles of manufacture described herein are not limited to the arrangements and instrumentality shown in the attached drawings.

### DETAILED DESCRIPTION

Although the following discloses example methods, apparatus, systems, and articles of manufacture including, among other components, firmware and/or software executed on hardware, it should be noted that such methods, apparatus, systems, and/or articles of manufacture are merely illustrative and should not be considered as limiting. For example, it is contemplated that any or all of these firmware, hardware, and/or software components could be embodied exclusively in hardware, exclusively in software, exclusively in firmware, or in any combination of hardware, software, and/or firmware. Accordingly, while the following describes example methods, apparatus, systems, and/or articles of manufacture, the examples provided are not the only way(s) to implement such methods, apparatus, systems, and/or articles of manufacture.

Generally, the example methods, apparatus, systems, and/or articles of manufacture described herein enable an exchange of linkage information associated with clinical items between healthcare entities. Linkage information includes, for example, indications of relationships between medical issues or problems of a patient and the clinical items associated with the medical issues or problems. Clinical items include, for example, medical records associated with aspects of treatment provided to a patient, such as medications, treatments, prescriptions, patient status, orders, procedures, medical images, lab results, etc. As an illustration, a first medical issue may be an irregular heartbeat diagnosed in a first patient by a healthcare practitioner. Any medication(s) prescribed to the patient by the healthcare practitioner in connection with the irregular heartbeat can be considered related to the irregular heartbeat. Additionally, any lab reports, scan results, and/or other process, procedure and/or protocols performed during the diagnosis and/or treatment of the irregular heartbeat can be considered related to the irregular heartbeat. The relationship between the prescribed medications, the lab reports, the scan results, etc. and the irregular heartbeat can be tracked or recorded as linkage information in association with medical records of the patient.

Linkage information is lost when, for example, patients are transferred from one healthcare entity to another. In particular, when clinical item data (e.g., medications, procedures, lab reports, etc.) is sent across disparate electronic medical record (EMR) systems of different healthcare entities, the linkage information does transfer therewith. For example, when using mapping information to facilitate transfer of data across different information systems (e.g., RxNorm to DDID mappings), certain clinical items would be uncoded either due to not finding a match or the clinical item itself being uncoded. That is, as the different healthcare information systems employ different standards, protocols, and/or terminology, clinical data is often transferred inaccurately or improperly. As a result, practitioners are often required to perform one or more reconciliations on clinical information received in association with a new, transferred patient. These reconciliation process(es) are crucial to the safe and successful treatment of patients and, thus, significantly benefit from methods and/or apparatus capable of increasing the accuracy, efficiency, and/or capacity thereof.

The example methods, apparatus, systems, and/or articles of manufacture disclosed herein enable exchanges of linkage information between healthcare entities and/or facilities. Enabling linkage information to be transferred between healthcare entities reduces or eliminates problems or disadvantages of the loss of linkage information when transferring patients from the care of one healthcare entity to another. For example, when clinical items received by the healthcare entity to which a patient was transferred cannot be coded correctly by the receiving healthcare entity, practitioners are required to reconcile (e.g., manually and without certainty) the clinical items with aspects of the medical records of the patient. Using the examples disclosed herein, the linkage information indicative of ties between the clinical items and the associated medical issues or problems is transferred to the receiving healthcare entity and presented to a healthcare practitioner thereof. As a result, the need for the receiving healthcare entity to reconcile information from the history of the patient is at least significantly reduced and, in some instances, eliminated.

In addition to preparing and transmitting linkage information related to a patient when the patient (or responsibility for the patient) is scheduled for transfer or has been transferred to the new healthcare entity, the examples disclosed herein implement a user interface configured to present the transferred linkage information to a practitioner associated with the new healthcare entity. Further, the example user interface disclosed herein can receive one or more selections from a practitioner. For example, the user interface disclosed herein enables the practitioner to select one or more clinical items based on the transferred linkage information for receipt by the receiving healthcare entity. Such selections can be based on, for example, a reason for the transfer of the patient (e.g., a specialty of the practitioner). That is, when the practitioner is charged with a limited aspect of the treatment being provided to the patient (e.g., at a specialist practice), the receiving practitioner can identify which clinical items are related to the medical issue or aspect with which the practitioner is charged. As a result, the example user interface disclosed herein enables the practitioner to provide, for example, more efficient care to the patient by focusing on relevant aspects of the received patient records.

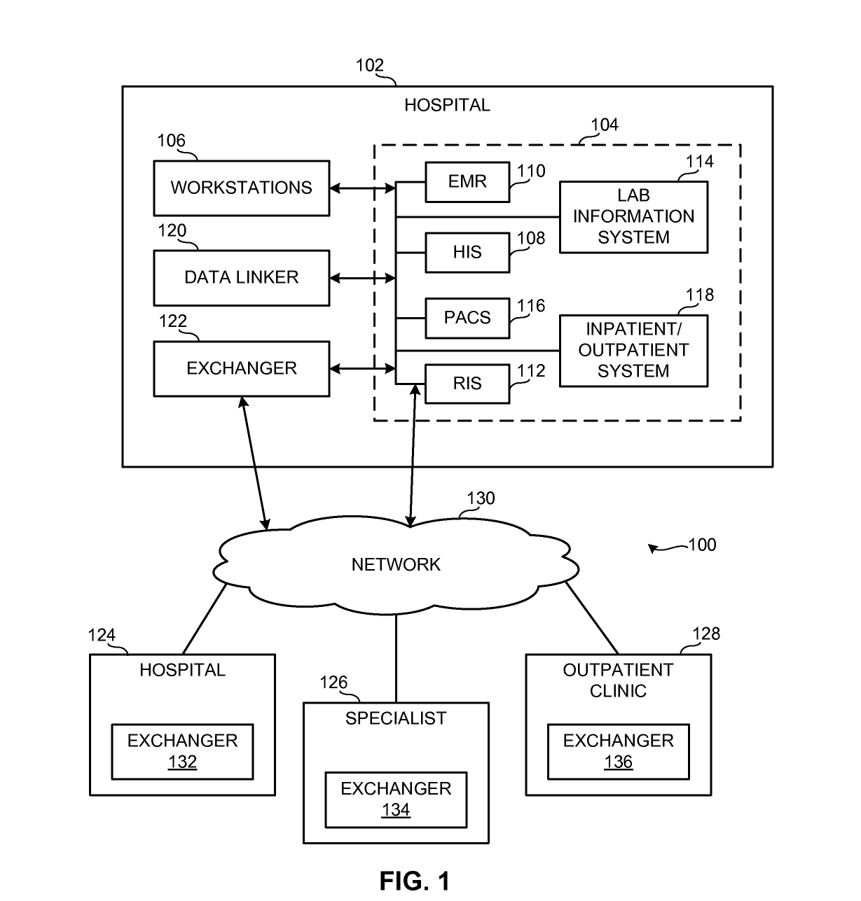

FIG. 1 is a block diagram of an example healthcare environment 100 in which the example methods, apparatus, systems, and/or articles of manufacture described herein to exchange linkage information between healthcare facilities may be implemented. The example healthcare environment 100 of FIG. 1 includes a first hospital 102 having an information system 104. The information system 104 of FIG. 1 includes a plurality of workstations, one of which is shown in FIG. 1 labeled with reference numeral 106. The workstation 106 may be any equipment (e.g., a personal computer) capable of executing software that permits electronic data (e.g., medical reports) and/or electronic medical images (e.g., x-rays, ultrasounds, MRI scans, medical reports, test results, etc.) to be acquired, stored, or transmitted for viewing and operation. The workstation 106 receives commands and/or other input from a user (e.g., a physician, surgeon, nurse, or any other healthcare practitioner) via, for example, a keyboard, mouse, track ball, microphone, etc. The example workstation 106 implements a user interface to enable a healthcare practitioner to interact with the information system 104 and the components thereof. For example, the workstation 106 may enable a practitioner to search one or more components of the information system 104 and/or one or more external databases. Further, the workstation 106 may enable a practitioner to enter, retrieve, analyze, etc. medical information associated with the components of the information system 104. In some examples, practitioners log on to the information system 104 via the workstation 106 thereby making his or her identity known to the information system 104.

The information system 104 includes a hospital information system (HIS) 108, an electronic medical record (EMR) system 110, a radiology information system (RIS) 112, a lab information system 114, a picture archiving and communication system (PACS) 116, and an inpatient/outpatient system 118. In the illustrated example, the HIS 108, the EMR system 1120, the RIS 112, the lab information system 114, the PACS 116, and the inpatient/outpatient system 118 are housed in the hospital 102a and locally archived. However, in other implementations, the HIS 108, the EMR system 1120, the RIS 112, the lab information system 114, the PACS 116, and/or the inpatient/outpatient system 118 may be housed one or more other suitable locations. Furthermore, one or more components of the healthcare data system 104 may be combined and/or implemented together. For example, the RIS 112 and/or the PACS 116 may be integrated with the HIS 108; the PACS 116 may be integrated with the RIS 112; and/or the six example information systems 110-118 may be integrated together. Preferably, information (e.g., test results, observations, diagnosis, discharges, admissions, etc.) is entered into the information system(s) 110-118 by healthcare practitioners (e.g., radiologists, physicians, technicians, administrators, etc.) before, after, and/or during a patient examination and/or testing session.

The HIS 108 stores healthcare information such as clinical reports, patient information, practitioner information, and/or financial data received from, for example, personnel at a hospital, clinic, and/or a physician's office. The EMR system 114 stores administrative information related to patients and/or practitioners, medical histories, current treatment records, etc. In some examples, the EMR system 113 stores information according to one or more departmental assignments and/or designations. The RIS 112 stores information such as, for example, radiology reports, messages, warnings, alerts, patient scheduling information, patient demographic data, patient tracking information, and/or physician and patient status monitors. Additionally, the RIS 112 enables exam order entry (e.g., ordering an x-ray of a patient) and image and film tracking (e.g., tracking identities of one or more people that have checked out a film).

The lab information system 114 stores clinical information such as lab results, test scheduling information, corresponding practitioner(s), and/or other information related to the operation(s) of one or more labs at the corresponding healthcare facility. The PACS 116 stores medical images (e.g., x-rays, scans, three-dimensional renderings, etc.) as, for example, digital images in a database or registry. Images are stored in the PACS 116 by healthcare practitioners (e.g., imaging technicians, physicians, radiologists) after a medical imaging of a patient and/or are automatically transmitted from medical imaging devices to the PACS 116 for storage. In some examples, the PACS 116 may also include a display device and/or viewing workstation to enable a healthcare practitioner to communicate with the PACS 116.

The inpatient/outpatient system 118 stores information related to the admission and discharge of patients such as follow up schedules, patient instructions provided by a practitioner, prescription information, presenting symptoms, contact information, etc.

While example types of information are described above as being stored in certain elements of the healthcare data system 104, different types of healthcare data may be stored in one or more of the HIS 108, the EMR system 110, the RIS 112, the lab information system 114, the PACS 116, and/or the inpatient/outpatient system 118. Further, the information stored in these elements may overlap and/or share types of data.

The HIS 108, the EMR system 1120, the RIS 112, the lab information system 114, the PACS 116, and/or the inpatient/outpatient system 118 may be in communication via, for example, a Wide Area Network (WAN) such as a private network or the Internet. More generally, any of the coupling(s) described herein may be via a network. In such instances, the network may be implemented by, for example, the Internet, an intranet, a virtual private network, a wired or wireless Local Area Network, and/or a wired or wireless Wide Area Network. In some examples, the healthcare data system 104 also includes a broker (e.g., a Mitra Imaging's PACS Broker) to allow medical information and medical images to be transmitted together and stored together. In some examples, information stored in one or more components of the healthcare data system 104 is formatted according to one or more protocols such as, for example, HL-7, DICOM, CCD, CCR, and/or CDA. The equipment used to obtain, generate, and/or store the information of the medical information system 106 may operate in accordance with, for example, one or more of these protocols.

The example hospital 102 also includes a data linker 120. The example data linker 120 generates and maintains linkage information for clinical records of, for example, the EMR 110 of the example information system 104. As described above, linkage information includes indications of relationships between clinical items (e.g., medications, prescriptions, diagnoses, lab results, scans, etc.) and the medical issues or problems with which the clinical items are related and/or from which the clinical items arose. To create the linkage information, the example data linker 120 receives a clinical item, identifies a medical issue or problem associated with the clinical item (e.g., by querying records of the EMR 110 and/or physician records (e.g., notes) associated with the clinical item), and generates data showing the identified relationship between the clinical item and the medical issue or problem. The example data linker 120 can store the generated linkage data in association with the received clinical item, integrate the generated linkage data into the clinical item, and/or store the generated linkage data in a dedicated database (e.g., as a component of the EMR 110). As a result, the example data linker 120 of FIG. 1 provides linkage information tying clinical items to the corresponding medical issues and maintains the linkage information in, for example, a memory or database of the hospital 102.

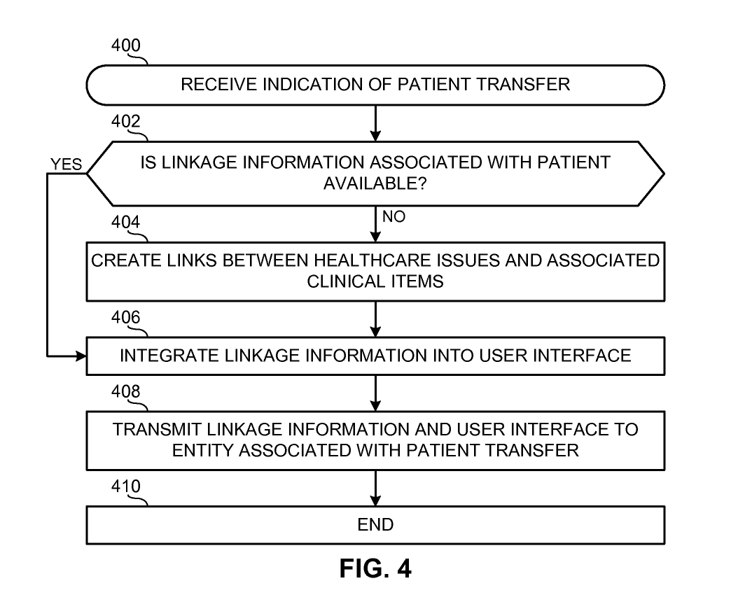

The example data linker 120 of FIG. 1 can utilize one or more aspects of standard and/or protocols (e.g., CCD (Continuity of Care), CCR (Continuity of Care Record), CDA (Clinical Document Architecture), HL-7 (Health Level 7), etc.) that enable and/or assist in creating links between clinical items and medical issues to create linkage information described herein. The example data linker 120 can create or update linkage information in response to, for example, entrance of new clinical items into the EMR 110, as a bulk function performed on records of the EMR 110, and/or at any other suitable time (e.g., in response to a patient transfer, as described in greater detail in connection with FIG. 4).

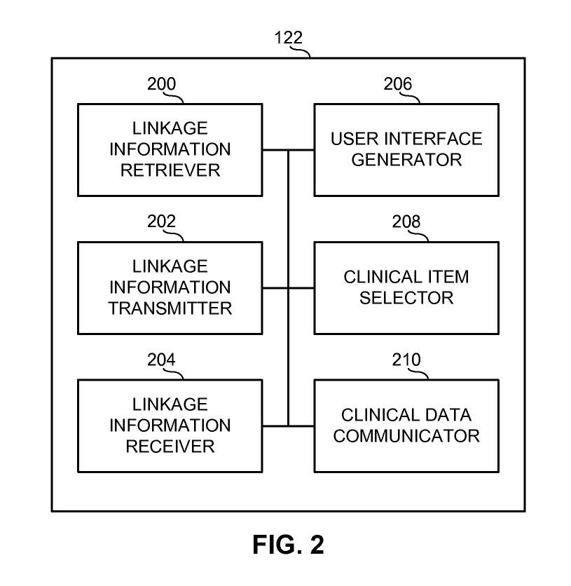

The example hospital 102 of FIG. 1 also includes an example exchanger 122. Generally, the example exchanger 122 of FIG. 1 enables linkage information, such as the linkage information generated and maintained by the example data linker 120, to be exchanged among healthcare entities. Further, the example exchanger 122 of FIG. 1 implements a user interface capable of communicating the linkage information to receiving healthcare entities and enabling practitioners associated with the receiving healthcare entities to interact with the linkage information. The example exchanger 122 of FIG. 1 and the user interface implemented thereby are described in greater detail below in connection with FIGS. 2-5.

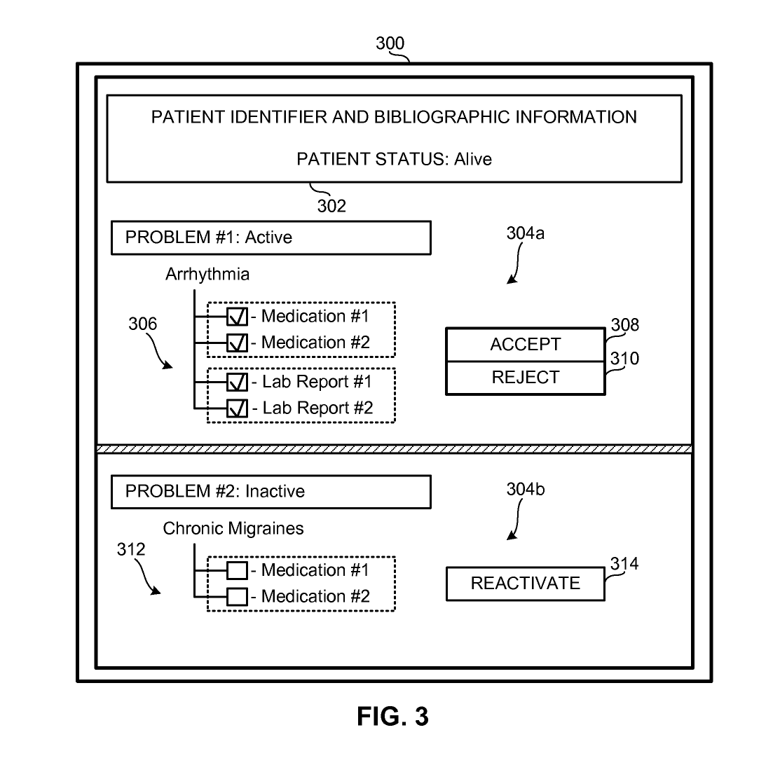

The example healthcare environment 100 of FIG. 1 also includes a second hospital 124, a specialist 126, and an outpatient clinic 128. In the illustrated example, the healthcare entities 102, 124, 126, and 128 are in communication via a network 130, such as the Internet. The example healthcare entities 102, 124, 126, and 128 may be in communication directly and/or via any additional or alternative networks, manners, devices, etc. Moreover, the example healthcare environment 100 of FIG. 1 can include any additional or alternative amount and/or type of healthcare entities, as the healthcare entities 102, 124, 126, and 128 illustrated in FIG. 1 are for purposes of illustration and not limitation. Furthermore, while FIG. 1 illustrates an information system 104, workstation(s) 106, a data linker 120 and an exchanger 122 implemented in association with the first hospital 102, the other entities (i.e., the second hospital 124, the specialist 126, and the outpatient clinic 128) may include additional, alternative, and/or similar components as those of the information system 104 of the first hospital 102. In the illustrated example of FIG. 1, the second hospital 124, the specialist 126 and the outpatient clinic 128 include exchangers 132, 134 and 136, respectively, configured in a similar manner as the example data exchanger 122. However, each healthcare entity can customized elements of the respective data exchanger 122 (e.g., preferences and/or settings of the user interface illustrated in FIG. 3) and/or the operation thereof.

FIG. 2 is a block diagram of an example apparatus that may be used to implement the example data exchanger 122 of FIG. 1. In the illustrated example of FIG. 2, the example data exchanger 122 includes a linkage information retriever 200, a linkage information transmitter 202, a linkage information receiver 204, a user interface generator 206, a clinical item selector 208, and a clinical item communicator 210. While an example manner of implementing the data exchanger 122 of FIG. 1 has been illustrated in FIG. 2, one or more of the elements, processes and/or devices illustrated in FIG. 2 may be combined, divided, re-arranged, omitted, eliminated and/or implemented in any other way. Further, the example linkage information retriever 200, the example linkage information transmitter 202, the example linkage information receiver 204, the example user interface generator 206, the example clinical item selector 208, the example clinical item communicator 210, and/or, more generally, the example data exchanger 122 of FIG. 2 may be implemented by hardware, software, firmware and/or any combination of hardware, software and/or firmware. Thus, for example, any of the example linkage information retriever 200, the example linkage information transmitter 202, the example linkage information receiver 204, the example user interface generator 206, the example clinical item selector 208, the example clinical item communicator 210, and/or, more generally, the example data exchanger 122 of FIG. 2 can be implemented by one or more circuit(s), programmable processor(s), application specific integrated circuit(s) (ASIC(s)), programmable logic device(s) (PLD(s)) and/or field programmable logic device(s) (FPLD(s)), etc. When any of the appended claims are read to cover a purely software and/or firmware implementation, at least one of the example linkage information retriever 200, the example linkage information transmitter 202, the example linkage information receiver 204, the example user interface generator 206, the example clinical item selector 208, the example clinical item communicator 210, and/or, more generally, the example data exchanger 122 of FIG. 2 are hereby expressly defined to include a tangible medium such as a memory, DVD, CD, etc., storing the software and/or firmware. Further still, the example data exchanger 122 of FIG. 2 may include one or more elements, processes and/or devices in addition to, or instead of, those illustrated in FIG. 2, and/or may include more than one of any or all of the illustrated elements, processes and devices.

The example linkage information retriever 200 of FIG. 2 obtains the linkage information described herein that is indicative of relationships between medical issues or problems and related clinical items. For example, the linkage information retriever 200 retrieves data (e.g., from the EMR 110 and/or any other component of the information system 104 that stores linkage information) showing a first medication was prescribed to a patient by a particular healthcare practitioner in connection with an irregular heartbeat. Other linkage information obtained by the example linkage information retriever 200 may include, for example, an indication of a relationship between certain lab results returned from a test or procedure (e.g., from the lab information system 114) that was ordered as a result of a detection of the irregular heartbeat by the same or a different healthcare practitioner. The linkage information may be expressed via one or more standards or protocols that include options for linking clinical items (e.g., medical records associated with aspects of treatment provided to a patient) and/or via a set of definitions and/or standards dedicated to linkage information (e.g., in connection with the example data exchangers 122, 132, 134, and 136 disclosed herein). Accordingly, the example linkage information retriever 200 is configured to utilize a plurality of standards or protocols to communicate with devices and/or systems that store linkage information. For example, the linkage information retriever 200 can query one or more components of the information system 104 via requests configured to obtain information from certain fields of medical records dedicated to linkage information. The example linkage information retriever 200 can obtain the linkage information described herein in any additional or alternative suitable manner.

The example linkage information transmitter 202 receives the obtained linkage information from the linkage information retriever 200 and communicates the same to one or more of the second hospital 124, the specialist 126, and the outpatient clinic 128. In the illustrated example of FIG. 2, the healthcare entity or entities to which the linkage information is communicate corresponds to the healthcare entity or entities to which the patient associated with the linkage information is being transferred or was transferred. As described herein, the transfer of linkage information to a healthcare entity receiving a new patient enables the practitioners of the receiving healthcare entity to be immediately and accurately aware of the interactions and relationships between medical issues or problems of a received patient and related clinical items. The transfer of linkage information by the example linkage information transmitter 202 may be made in conjunction with a transfer of the medical records themselves or as a standalone transmission.

In some examples, the linkage information is transferred by the linkage information transmitter 202 of the exchanger 122 of the first hospital 102 to the exchangers 132, 134, 136 of the second hospital 124, the specialist 126 and the outpatient clinic 128, respectively. Such a transfer is triggered by, for example, a transfer of a corresponding patient from the first hospital 102 to one or more of the second hospital 124, the specialist 16 and the outpatient clinic 128. In some examples, the transfer of the linkage information by the linkage information transmitter 202 is triggered without a patient transfer. In turn, the exchanger 122 of the first hospital 102 can receive linkage information from the exchangers 132, 134, 136 of the second hospital 124, the specialist 126 and the outpatient clinic 128, respectively. To receive and process the linkage information, the data exchanger 122 includes the linkage information receiver 204. The example linkage information receiver 204 recognizes the received data as linkage information and stores the same in memory. In some examples, the linkage information can be received by device(s) in addition to or in lieu of the linkage information receiver 204, such as a general reception system of the EMR 110. As described below, the example linkage information receiver 204 interacts with the example user interface generator 206 to present the received linkage information to a healthcare practitioner.

The example user interface generator 206 generates a user interface capable of communicating received linkage information to one or more healthcare practitioners and enabling automatic reconciliation of clinical items associated with the linkage information. As described above, the example data exchanger 122 is configured to receive (e.g., via the linkage information receiver 204) linkage information from, for example, the second hospital 124 in response to, for example, a transfer of a corresponding patient from the second hospital 124 to the first hospital 102. The example user interface generator 206 receives the linkage information from the linkage information receiver 204 and integrates the linkage information into a user interface to be displayed to a healthcare practitioner associated with the first hospital 102. In the illustrated example, the user interface into which the user interface generator 206 integrates the linkage information is dedicated to the data exchanger 122. However, the example user interface generator 206 is capable of implementing a user interface to communicate the linkage information as part of a broader user interface as, for example, a portion of the broader user interface. That is, the user interface generator 206 can implement the linkage information user interface as a standalone application or in combination with other user interface(s).

An example implementation of a user interface 300 implemented by the example user interface generator 206 is illustrated in FIG. 3. The example user interface 300 of FIG. 3 includes a patient identification section 302, which includes information associated with a patient that is the subject of a transfer. The information of the identification section 302 can include bibliographic data, demographic data, status information, etc. indicative of one or more aspects of the patient.

The example user interface 300 of FIG. 3 includes a plurality of medical issue sections 304, each corresponding to a medical issue associated with the transfer patient. A first issue section 304a is labeled as ‘Problem #1’ in the illustrated example of FIG. 3. The example user interface generator 206 references the linkage information to determine whether the first medical issue is active or inactive and integrates an indication of the status into the user interface 300. The exchangers 122, 132, 134 and 136 described herein can operate according to a hierarchy of patient statuses (e.g., active, inactive, deceased, etc.) that determines how the related clinical items are reconciled (e.g., by default or in response to a specific user instruction). In the illustrated example, the status is listed adjacent the label of ‘Problem 1.’ For purposes of illustration, the first medical issue is an irregular heartbeat or arrhythmia and the arrhythmia is currently an active issue. Accordingly, the example user interface generator 206 labels the first medical issue as active and as an ‘Arrhythmia’ as shown in FIG. 3.

To express the received linkage information to a user, the example user interface generator 206 generates a list 306 including a plurality of treatment aspects linked to the first issue (i.e., a case of arrhythmia). In the illustrated example of FIG. 3, the linkage list 306 includes two medications prescribed in connection with the arrhythmia and two lab reports associated with tests ordered in connection with the arrhythmia. The list 306 includes a check box for each of the treatment aspects linked to the corresponding medical issue. In the illustrated example, as ‘Problem 1’ is active, each check box of the list 306 is checked and prepared to be automatically reconciled. However, the check boxes are selectable by a user (e.g., a healthcare practitioner) such that the user can select one or more of the treatment aspects (i.e., clinical items) from the list 306 for which the user wants or does not want to obtain relevant clinical documentation (e.g., copies of prescription orders, images associated with the lab reports, etc.). In the illustrated example of FIG. 2, the example clinical item selector 208 is in communication with the user interface 300 and the check boxes thereof. When the desired treatment aspects are selected in the list 306, the user can engage an ‘Accept’ button 308 to initiate a reconciliation process implemented by the clinical item selector 208 of obtaining the clinical documentation associated with the selected clinical items.

In particular, the clinical item selector 208 determines which of the check boxes were selected when the ‘Accept’ button 308 was engaged. When a problem is active, like ‘Problem 1’ of the illustrated example, the related clinical items are reconciled automatically in response to engagement of the ‘Accept’ button 308 and the check boxes remaining selected. The example clinical item selector 208 identifies the clinical items that correspond to the selected check boxes and conveys the identifications to the clinical data communicator 210. The example clinical data communicator 210 obtains the selected information by, for example, submitting requests to the transferring healthcare entity, pulling the documentation from a healthcare information sharing system, and/or any other suitable manner of obtaining clinical documentation. Conversely, the list 306 also enables a user to de-select the check boxes of unwanted treatment aspects. In such instances, the user can de-select the unwanted treatment aspects or clinical items before engaging the ‘Accept’ button 308. The example user interface 300 of FIG. 3 also includes a ‘Reject’ button 310 to enable the practitioner to reject the corresponding problem. Thus, in the example of FIG. 3, a practitioner can engage the ‘Reject’ button 310 to reject the group of clinical items associated with ‘Problem 1.’

A second medical issue section 304b of the example user interface 300 of FIG. 3 includes an inactive medical issue labeled as ‘Problem 2.’ For example, the medical issue may have been resolved, in remission, and/or otherwise not currently relevant to the healthcare of the patient. In the illustrated example, the second medical issue is chronic migraines that are not currently an issue for the patient. The user interface generator 206 provides an option for the user to reactivate the medical issue of the second issue section 304b via a ‘Reactivate’ button 314. The second issue section 304b includes a list 312 similar to the list 306 of the first issue section 304a that operates in a similar fashion as the list 306 of the first issue section 304a. However, in the illustrated example, the clinical items related to the inactive ‘Problem 2’ are not automatically reconciled (e.g., by selecting each item of the list 312 by default). However, the practitioner can instruct the data exchanger 122 to reconcile one or more clinical items of the list 312 by selecting the associated check boxes and engaging the ‘Reactivate’ button 314.

While the example user interface 300 and the example user interface generator 206 are described above as having the receiving user interface generator integrate the linkage information into a user interface, the transmitting user interface generator (e.g., the user interface generator of the outpatient clinic 128 in the example described above) can also integrate the linkage information into a user interface and can include the user interface having the linkage information integrated therein in a transmission to the receiving data exchanger. Alternatively, a first subset of the operation(s) described herein in connection with the user interface can be performed by the user interface generator 206 of the receiving date exchanger (e.g., the data exchanger 122 of the first hospital 102 in the example above) while a second subset of the operation(s) described herein in connection with the user interface can be performed by a user interface generator of the transmitting data exchanger (e.g., the data exchanger 136 of the outpatient clinic 128 in the example above). That is, the operation(s) of the example user interface generator 206 can be split up among multiple data exchangers 122, 132, 134, 136.

Thus, using the example user interfaces generated by the example user interface generators and/or, more generally, the example data exchangers described herein, a healthcare practitioner of a receiving entity can process transfer information in a focused, efficient manner. Instead of receiving a plurality of unlinked medical documents associated with a patient and having to reconcile the same, the example data exchangers described herein enable the healthcare practitioner to be immediately aware of medical issues with which each medical document is associated. Moreover, the example data exchangers described herein enable the healthcare practitioner to focus the transfer of information on a medical issue for which the patient was transferred to that specific healthcare practitioner. For example, when the patient is being transferred from the first hospital 102 to the specialist 126 for rehabilitation of a spinal cord injury, the specialist 126 is informed of which treatment aspects are linked to the spinal cord injury and is enabled by the examples described herein to select appropriate clinical documentation for transfer or import. Among other benefits, such a system and associated methods improve patient safety by reducing, if not eliminating errors resulting from unrelated treatment aspects (e.g., medications) confusing a practitioner or staff.

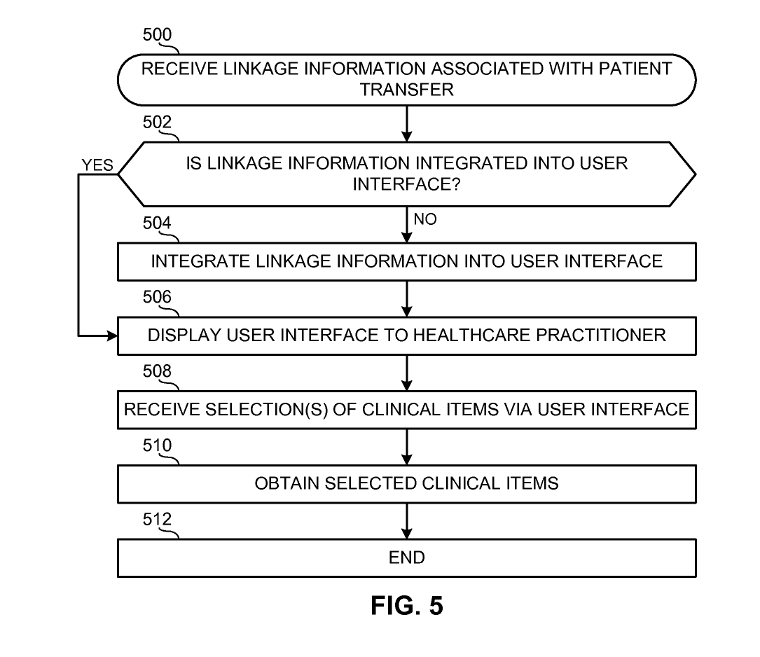

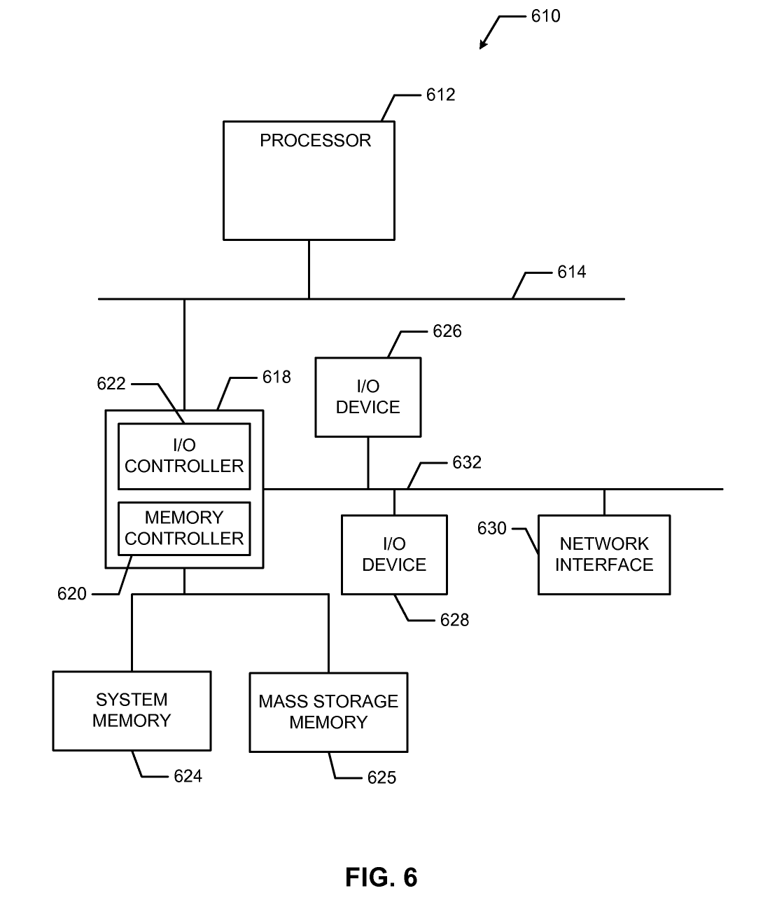

Turning to FIGS. 4 and 5, the flow diagrams depicted in FIGS. 4 and 5 are representative of machine readable instructions that can be executed to implement the example data exchanger 122 of FIGS. 1 and/or 2 to exchange linkage information associated with clinical items of healthcare information systems. The example processes of FIGS. 4 and 5 may be performed using a processor, a controller and/or any other suitable processing device. For example, the example processes of FIGS. 4 and 5 may be implemented in coded instructions stored on a tangible medium such as a flash memory, a read-only memory (ROM) and/or random-access memory (RAM) associated with a processor (e.g., the example processor 612 discussed below in connection with FIG. 6). Alternatively, some or all of the example processes of FIG. 3 may be implemented using any combination(s) of application specific integrated circuit(s) (ASIC(s)), programmable logic device(s) (PLD(s)), field programmable logic device(s) (FPLD(s)), discrete logic, hardware, firmware, etc. Also, some or all of the example processes of FIGS. 4 and 5 may be implemented manually or as any combination(s) of any of the foregoing techniques, for example, any combination of firmware, software, discrete logic and/or hardware. Further, although the example processes of FIGS. 4 and 5 are described with reference to the flow diagrams of FIGS. 4 and 5, other methods of implementing the processes of FIGS. 4 and 5 may be employed. For example, the order of execution of the blocks may be changed, and/or some of the blocks described may be changed, eliminated, sub-divided, or combined. Additionally, any or all of the example processes of FIGS. 4 and 5 may be performed sequentially and/or in parallel by, for example, separate processing threads, processors, devices, discrete logic, circuits, etc.

The example flow diagram of FIG. 4 illustrates example processes to be performed by the example data exchanger 122 in association with the data exchanger 122 being tasked with transferring linkage information from the first hospital 102 to another healthcare entity (e.g., the second hospital 124, the specialist 126, the outpatient clinic 128, and/or other types of healthcare entities). The example flow diagram of FIG. 4 begins with a reception of an indication of a patient transfer at the data exchanger 122 of the first hospital 102 (block 400). The indication of the patient transfer may be provided to the data exchanger 122 by, for example, an administration system associated with the first hospital 102 and/or any other suitable source. For example, after a surgical procedure performed on the patient, the inpatient/outpatient 118 system of FIG. 1 can notify the example exchanger 122 that the patient is slated to be transferred to the outpatient clinic 128. In response, the linkage information retriever 200 determines whether linkage information associated with the patient is available (block 402). If not, the linkage information retriever 202 instructs the data linker 120 to generate and/or obtain linkage information indicative of relationships between medical issues of the patient and different clinical items related to the medical issues (block 404).

Whether the linkage information was available at block 402 or generated at block 404, the example user interface generator 206 integrates the linkage information into, for example, the user interface 300 of FIG. 3 (block 406). In the illustrated example, the example user interface generator 206 integrates the linkage information by listing clinical items in association with the related medical issues (e.g., via the example lists 306 and 312 of FIG. 3). The example linkage information transmitter 202 then conveys the linkage information and the user interface integrations to the healthcare entity to which the patient is scheduled for transfer (block 408). The example flow diagram of FIG. 4 then ends (block 410).

In some examples, the user interface generator 206 does not integrate the linkage information as part of the transmitting process corresponding. In such instances, block 406 may be skipped in the example flow diagram of FIG. 3. Instead, the linkage information is integrated by at the receiving healthcare entity.

The example flow diagram of FIG. 5 illustrated example processes to be performed by the example data exchanger 122 in association with the data exchanger 122 being tasked with receiving linkage information from another healthcare entity (e.g., the second hospital 124, the specialist 126, the outpatient clinic 128, and/or other types of healthcare entities). The example flow diagram of FIG. 5 begins with the linkage information receiver 204 of the data exchanger 122 receiving a transfer of linkage information from a healthcare entity (block 500). The example linkage information receiver 204 determines whether the received linkage information was integrated into a user interface by, for example, a user interface generator of an exchanger of the transferring healthcare entity (e.g., the exchanger 132 of the second hospital 124, the exchanger 134 of the specialist 126, the exchanger 136 of the outpatient clinic 128) (block 502). If not, the user interface generator 206 of FIG. 2 integrates the received linkage information into a user interface, such as the example user interface 300 of FIG. 3 (block 504). The user interface having the linkage information integrated therein is then displayed to a healthcare practitioner (block 506). As described above in connection with FIG. 3, the healthcare practitioner is enabled to select clinical items associated with medical issues relevant to that healthcare practitioner and/or a purpose for which the patient was transferred to the first hospital 102. Accordingly, the example clinical item selector 208 of FIG. 2 receives such selections via the user interface (block 508). In the illustrated example, the clinical item selector 208 informs the clinical data communicator 210 of FIG. 2 of the selections and the clinical data communicator 210 obtains the corresponding clinical information associated with the receive selections (block 510). The example flow diagram of FIG. 5 then ends (block 512).

FIG. 6 is a block diagram of an example processor system 610 that may be used to implement the apparatus and methods described herein. As shown in FIG. 6, the processor system 610 includes a processor 612 that is coupled to an interconnection bus 614. The processor 612 may be any suitable processor, processing unit or microprocessor. Although not shown in FIG. 6, the system 610 may be a multi-processor system and, thus, may include one or more additional processors that are identical or similar to the processor 612 and that are communicatively coupled to the interconnection bus 614.

The processor 612 of FIG. 6 is coupled to a chipset 618, which includes a memory controller 620 and an input/output (I/O) controller 622. As is well known, a chipset typically provides I/O and memory management functions as well as a plurality of general purpose and/or special purpose registers, timers, etc. that are accessible or used by one or more processors coupled to the chipset 618. The memory controller 620 performs functions that enable the processor 612 (or processors if there are multiple processors) to access a system memory 624 and a mass storage memory 625.

The system memory 624 may include any desired type of volatile and/or non-volatile memory such as, for example, static random access memory (SRAM), dynamic random access memory (DRAM), flash memory, read-only memory (ROM), etc. The mass storage memory 625 may include any desired type of mass storage device including hard disk drives, optical drives, tape storage devices, etc.

The I/O controller 622 performs functions that enable the processor 612 to communicate with peripheral input/output (I/O) devices 626 and 628 and a network interface 630 via an I/O bus 632. The I/O devices 626 and 628 may be any desired type of I/O device such as, for example, a keyboard, a video display or monitor, a mouse, etc. The network interface 630 may be, for example, an Ethernet device, an asynchronous transfer mode (ATM) device, an 802.11 device, a DSL modem, a cable modem, a cellular modem, etc. that enables the processor system 610 to communicate with another processor system.

While the memory controller 620 and the I/O controller 622 are depicted in FIG. 6 as separate blocks within the chipset 618, the functions performed by these blocks may be integrated within a single semiconductor circuit or may be implemented using two or more separate integrated circuits.

Thus, the example methods, apparatus, systems, and/or articles of manufacture disclosed herein enable an exchange of linkage information between healthcare entities such that healthcare practitioners associated with entities are quickly, efficiently, and accurately made aware of clinical items associated with medical issues of transferred patients. In addition to other benefits and advantages, the example methods, apparatus, systems, and/or articles of manufacture disclosed herein reduce or, in some instances, eliminate the need for the practitioners to reconcile clinical items with medical issues. As a result, the practitioners can provide more accurate and safe care in a more efficient manner. Additionally, the practitioners can focus a transfer process and the exchange of information associated therewith on the clinical items related to the medical issue(s) for which the patient is being transferred.

Certain embodiments contemplate methods, systems and computer program products on any machine-readable media to implement functionality described above. Certain embodiments may be implemented using an existing computer processor, or by a special purpose computer processor incorporated for this or another purpose or by a hardwired and/or firmware system, for example.

Certain embodiments include computer-readable media for carrying or having computer-executable instructions or data structures stored thereon. Such computer-readable media may be any available media that may be accessed by a general purpose or special purpose computer or other machine with a processor. By way of example, such computer-readable media may comprise RAM, ROM, PROM, EPROM, EEPROM, Flash, CD-ROM or other optical disk storage, magnetic disk storage or other magnetic storage devices, or any other medium which can be used to carry or store desired program code in the form of computer-executable instructions or data structures and which can be accessed by a general purpose or special purpose computer or other machine with a processor. Combinations of the above are also included within the scope of computer-readable media. Computer-executable instructions comprise, for example, instructions and data which cause a general purpose computer, special purpose computer, or special purpose processing machines to perform a certain function or group of functions.

Generally, computer-executable instructions include routines, programs, objects, components, data structures, etc., that perform particular tasks or implement particular abstract data types. Computer-executable instructions, associated data structures, and program modules represent examples of program code for executing steps of certain methods and systems disclosed herein. The particular sequence of such executable instructions or associated data structures represent examples of corresponding acts for implementing the functions described in such steps.

Embodiments of the present invention may be practiced in a networked environment using logical connections to one or more remote computers having processors. Logical connections may include a local area network (LAN) and a wide area network (WAN) that are presented here by way of example and not limitation. Such networking environments are commonplace in office-wide or enterprise-wide computer networks, intranets and the Internet and may use a wide variety of different communication protocols. Those skilled in the art will appreciate that such network computing environments will typically encompass many types of computer system configurations, including personal computers, hand-held devices, multi-processor systems, microprocessor-based or programmable consumer electronics, network PCs, minicomputers, mainframe computers, and the like. Embodiments of the invention may also be practiced in distributed computing environments where tasks are performed by local and remote processing devices that are linked (either by hardwired links, wireless links, or by a combination of hardwired or wireless links) through a communications network. In a distributed computing environment, program modules may be located in both local and remote memory storage devices.

Although certain methods, apparatus, and articles of manufacture have been described herein, the scope of coverage of this patent is not limited thereto. To the contrary, this patent covers all methods, apparatus, and articles of manufacture fairly falling within the scope of the appended claims either literally or under the doctrine of equivalents.

What is claimed is:

1. A computer implemented method for use with a healthcare information system, comprising:
detecting a patient transfer associated with a patient from a first healthcare entity to a second healthcare entity;
obtaining linkage information indicative of a relationship between a clinical item of treatment associated with the patient and a medical issue of the patient;
transferring the linkage information to the second healthcare entity in response to the detected patient transfer;
enabling a healthcare practitioner associated with the second healthcare entity to view the linkage information such that the relationship is visually conveyed to the healthcare practitioner; and
enabling the healthcare practitioner to accept the medical issue of the patient to initiate an automatic reconciliation process.

2. A computer implemented method as defined in claim 1, wherein enabling the healthcare practitioner to view the linkage information comprising integrating the linkage information into a user interface to be presented to the healthcare practitioner.

3. A computer implemented method as defined in claim 2, wherein the user interface comprises a first indication of the medical issue and a second indication of the clinical item, and wherein the first indication and the second indication are visually tied together.

4. A computer implemented method as defined in claim 1, further comprising obtaining data associated with the clinical item when the healthcare practitioner accepts the medical issue.

5. A computer implemented method as defined in claim 1, further comprising transferring a patient status with the linkage information, and wherein the patient status determines whether aspects of the reconciliation process are performed automatically or in response to a user instruction.

6. A computer implemented method as defined in claim 1, wherein the clinical item comprises one of a prescription, a procedure, a lab result, and a report associated with the medical issue.

7. A computer implemented method as defined in claim 1, further comprising receiving the linkage information at the second healthcare entity and integrating the linkage information into user interface to be displayed to the healthcare practitioner.

8. A computer implemented method as defined in claim 1, wherein detecting the patient transfer comprises receiving data from an outpatient administrative system.

9. A tangible computer readable medium having instructions stored thereon that, when executed, cause a machine to at least:
detect a patient transfer associated with a patient from a first healthcare entity to a second healthcare entity;
obtain linkage information indicative of a relationship between a clinical item of treatment associated with the patient and a medical issue of the patient;
transfer the linkage information to the second healthcare entity in response to the detected patient transfer;
enable a healthcare practitioner associated with the second healthcare entity to view the linkage information such that the relationship is visually conveyed to the healthcare practitioner; and
enable the healthcare practitioner to accept the medical issue of the patient to initiate an automatic reconciliation process.

10. A tangible computer readable medium as defined in claim 9, wherein the instructions enable the healthcare practitioner to view the linkage information by integrating the linkage information into a user interface to be presented to the healthcare practitioner.

11. A tangible computer readable medium as defined in claim 10, wherein the user interface comprises a first indication of the medical issue and a second indication of the clinical item, and wherein the first indication and the second indication are visually tied together.

12. A tangible computer readable medium as defined in claim 9 having instructions stored thereon that, when executed, obtain data associated with the clinical item when the healthcare practitioner accepts the medical issue.

13. A tangible computer readable medium as defined in claim 9 having instructions stored thereon that, when executed, transfer a patient status with the linkage information, and wherein the patient status determines whether aspects of the reconciliation process are performed automatically or in response to a user instruction

14. A tangible computer readable medium as defined in claim 9, wherein the clinical item comprises one of a prescription, a procedure, a lab result, and a report associated with the medical issue.

15. A tangible computer readable medium as defined in claim 9 having instructions stored thereon that, when executed, receive the linkage information at the second healthcare entity and integrating the linkage information into user interface to be displayed to the healthcare practitioner.

16. A tangible computer readable medium as defined in claim 9, wherein the instructions detect the patient transfer by receiving data from an outpatient administrative system.

17. An apparatus for use in a healthcare information system, comprising:
a retriever to obtain linkage information indicative of a relationship between a clinical item of treatment associated with a patient and a medical issue of the patient in response to an indication of a patient transfer from a first healthcare entity to a second healthcare entity;
a transmitter to transfer the linkage information to the second healthcare entity in response to the detected patient transfer;
a generator to enable a healthcare practitioner associated with the second healthcare entity to view the linkage information such that the relationship is visually conveyed to the healthcare practitioner; and
a selector to enable the healthcare practitioner to accept the medical issue of the patient to initiate an automatic reconciliation process.

18. An apparatus as defined in claim 17, wherein the generator enables the healthcare practitioner to view the linkage information by integrating the linkage information into a user interface to be presented to the healthcare practitioner.

19. An apparatus as defined in claim 18, wherein the user interface comprises a first indication of the medical issue and a second indication of the clinical item, and wherein the first indication and the second indication are visually tied together.

20. An apparatus as defined in claim 18, wherein the user interface comprises an option for the healthcare practitioner to reject reconciliation of the clinical item.

21. An apparatus as defined in claim 17, further comprising a communicator to obtain data associated with the clinical item when the healthcare practitioner selects the clinical item

22. An apparatus as defined in claim 17, wherein the clinical item comprises one of a prescription, a procedure, a lab result, and a report associated with the medical issue.

23. An apparatus as defined in claim 17, further comprising a receiver to receive the linkage information at the second healthcare entity and integrating the linkage information into user interface to be displayed to the healthcare practitioner.
